(19) United States
(12) Patent Application Publication
(10) Pub. No.: US 2023/0012530 A1
(43) Pub. Date: Jan. 19, 2023

(54) REMOTE PARKING SYSTEM AND PARKING ASSISTANCE CONTROL APPARATUS USED THEREIN

(71) Applicant: DENSO CORPORATION, Kariya-city (JP)

(72) Inventor: Koutarou ISHIMOTO, Kariya-city (JP)

(21) Appl. No.: 17/936,272

(22) Filed: Sep. 28, 2022

Related U.S. Application Data
(63) Continuation of application No. PCT/JP2021/012938, filed on Mar. 26, 2021.

(30) Foreign Application Priority Data
Mar. 31, 2020 (JP) 2020-063146

(51) Int. Cl. G05D 1/00; G06V 20/58; H04N 5/268; H04N 5/262; B60W 30/06; B60R 25/20; B60R 25/24

(52) U.S. Cl. CPC G05D 1/0038; G06V 20/586; H04N 5/268; H04N 5/2628; B60W 30/06; B60R 25/209; B60R 25/24; H04N 7/183

(57) ABSTRACT

A remote parking system performs remote parking in which a vehicle is moved from a current position and parked by remote parking. In the remote parking system, a remote controller can be carried outside the vehicle, issues an instruction for remote parking by being operated by an operator, and includes a display screen that displays a state of remote parking. An imaging apparatus captures a peripheral image of the vehicle. A control unit inputs imaging data from the imaging apparatus, and includes an image generating unit that generates an image to be displayed on the display screen based on the imaging data. The image generating unit generates, as a remote parking image, an image in a direction along a line of sight in which a vehicle direction is viewed from the operator. The image includes a blind spot position positioned on a side opposite the operator relative to the vehicle.

### CROSS-REFERENCE TO RELATED APPLICATION

The present application is a continuation application of International Application No. PCT/JP2021/012938, filed on Mar. 26, 2021, which claims priority to Japanese Patent Application No. 2020-063146, filed on Mar. 31, 2020. The contents of these applications are incorporated herein by reference in their entirety.

### BACKGROUND

### Technical Field

The present disclosure relates to a remote parking system and a parking assistance control apparatus used therein.

### Related Art

In a remote parking system, a method has been proposed in which a direction of a top view is changed based on a positional relationship among a vehicle, an operator, and a target control position. In this method, for example, a parking assistance control apparatus is known that includes an onboard electronic control unit (ECU) that acquires a sensing result from an onboard camera, and generates, from the sensing result, a top view image that is an image of the vehicle viewed from directly above.

### SUMMARY

One aspect of the present disclosure provides a remote parking system that performs remote parking in which a vehicle is moved from a current position to a parking intended position and parked by remote parking. The remote parking system includes a remote controller, an imaging apparatus, and a control unit. The remote controller is an apparatus that can be carried outside the vehicle, issues an instruction for remote parking by being operated by an operator, and includes a display screen that displays a state of remote parking. The imaging apparatus is provided in the vehicle and captures a peripheral image of the vehicle. The control unit is provided in the vehicle, inputs imaging data of the peripheral image from the imaging apparatus and includes an image generating unit that generates an image to be displayed on the display screen based on the imaging data. The image generating unit generates, as a remote parking image, an image in a direction along a line of sight in which a vehicle direction is viewed from the operator. The image includes a blind spot position that is positioned on a side opposite the operator relative to the vehicle.

### BRIEF DESCRIPTION OF THE DRAWINGS

In the accompanying drawings:

FIG. 1 is a block diagram illustrating a remote parking system according to a first embodiment;

FIG. 2 is a flowchart illustrating an operation control process performed by a remote controller;

FIG. 3 is a flowchart illustrating a control process performed by a cockpit ECU;

FIG. 4 is a flowchart illustrating image processing performed by an image ECU;

FIG. 5 is a flowchart illustrating an automatic parking process performed by an automatic parking ECU;

FIG. 6 is a diagram illustrating states of a background and a state of a display screen of the remote controller when an own vehicle is being remotely parked in a free space, as a comparison example;

FIG. 7 is a diagram illustrating a state when a parking cone is captured in a top view image;

FIG. 8 is a diagram illustrating a background and a state of the display screen of the remote controller when the own vehicle is being remotely parked in a free space in the remote parking system according to the first embodiment;

FIG. 9 is a diagram illustrating a display area of each image displayed on the display screen of the remote controller;

FIG. 10 is a diagram illustrating a background and a state of a display screen of a remote controller when an own vehicle is being remotely parked in a free space in a remote parking system according to a second embodiment;

FIG. 11 is a diagram illustrating a background and a state of a display screen of a remote controller when an own vehicle is being remotely parked in a free space, according to another embodiment; and

FIG. 12 is a diagram illustrating a background and a state of a display screen of a remote controller when an own vehicle is being remotely parked in a free space, according to another embodiment.

### DESCRIPTION OF THE EMBODIMENTS

The following embodiments of the present disclosure relate to a remote parking system that automatically parks a vehicle by remote control and a parking assistance control apparatus that is used in the remote parking system.

Conventionally, as shown in JP-A-2019-156310, in a remote parking system, a method in which a direction of a top view is changed based on a positional relationship among a vehicle, an operator, and a target control position has been proposed. Specifically, in an onboard electronic control unit (ECU) that is a part of a parking assistance control apparatus, a sensing result from an onboard camera is acquired, and a top view image that is an image of the vehicle viewed from directly above is generated from the sensing result. Then, when the vehicle is to be parked in a parking target position, an orientation of a parking target in the top view image relative to a display screen is determined based on a positional relationship between an operator who remotely controls the vehicle through a remote controller and the parking target position.

In the remote parking system, the operator is required to monitor safety of a vehicle vicinity from outside the vehicle. Regarding a position that is a blind spot on a side opposite the operator relative to the vehicle, the operator performs safety monitoring through the display screen of the remote controller. However, in the method disclosed in JP-A-2019-156310, a situation on the side opposite the operator with the vehicle therebetween is difficult to accurately ascertain.

Specifically, in an aspect in which the top view is displayed on the display screen, the top view image is generated based on imaging data from the onboard camera that is attached to front and rear or left and right of the vehicle. At this time, through use of the onboard camera in which an optical system is a fisheye lens or the like, an image in which an imaging center axis is substantially oriented in a horizontal direction is captured. Viewpoint conversion is performed on the captured image, and the top view image is generated. Therefore, as a result of an obstacle in the vehicle vicinity being shown by an image that has distortion or the like, the operator is unable to accurately ascertain a distance relationship between the vehicle and the obstacle.

It is thus desired to provide a remote parking system that is capable of more accurately performing safety monitoring even in a position that is a blind spot on a side opposite an operator relative to a vehicle, and a parking assistance control apparatus that is used in the remote parking system.

An exemplary embodiment of the present disclosure provides a remote parking system that performs remote parking in which a vehicle is moved from a current position to a parking intended position and parked by remote parking. The remote parking system includes: a remote controller that is an apparatus that can be carried outside the vehicle, issues an instruction for remote parking by being operated by an operator, and includes a display screen that displays a state of remote parking; an imaging apparatus that is provided in the vehicle and captures a peripheral image of the vehicle; and a control unit that is provided in the vehicle, inputs imaging data of the peripheral image from the imaging apparatus, and includes an image generating unit that generates an image to be displayed on the display screen based on the imaging data. The image generating unit generates, as a remote parking image, an image in a direction along a line of sight in which a vehicle direction is viewed from the operator. The image includes a blind spot position that is positioned on a side opposite the operator relative to the vehicle.

In this manner, an image that shows a blind spot that is hidden by an own vehicle is generated as the remote parking image, and the remote parking image is displayed on the display screen of the remote controller rather than a top view image. Specifically, an image that is an image in which a direction of the own vehicle is viewed from the operator and shows the blind spot that is positioned on the side opposite the operator relative to the own vehicle serves as the remote parking image. Consequently, a state in which an obstacle is viewed from the operator can be displayed as an image on the display screen. The operator can accurately ascertain a distance relationship between the own vehicle and the obstacle through the image. Safety monitoring can be performed with more accuracy.

Another exemplary embodiment of the present disclosure provides a parking assistance control apparatus that performs remote parking in which a vehicle is moved from a current position to a parking intended position and parked based on an operation in a remote controller that can be carried outside the vehicle. The parking assistance control apparatus includes: a control unit that inputs imaging data of a peripheral image from an imaging apparatus that captures the peripheral image of the vehicle and includes an image generating unit that performs generation of an image to be displayed on a display screen based on the imaging data. The control unit: causes the image generating unit to generate, as a remote parking image, an image to be displayed on the display screen, the image being in a direction along a line of sight in which a vehicle direction is viewed from the operator and including a blind spot position that is positioned on a side opposite an operator of the remote controller relative to the vehicle; and subsequently transmits the remote parking image to the remote controller and causes a display screen of the remote controller to display the remote parking image.

In this manner, an image that shows a blind spot that is hidden by an own vehicle is generated as the remote parking image, and the remote parking image is displayed on the display screen of the remote controller rather than a top view image. Consequently, a state in which an obstacle is viewed from the operator can be displayed as an image on the display screen. The operator can accurately ascertain a distance relationship between the own vehicle and the obstacle through the image. Safety monitoring can be performed with more accuracy.

Here, reference numbers within parentheses that are attached to constituent elements and the like indicate an example of corresponding relationships between the constituent elements and the like and specific constituent elements and the like according to embodiments described hereafter.

Embodiments of the present disclosure will hereinafter be described with reference to the drawings. Here, sections among the embodiments below that are identical or equivalent to each other are described with the same reference numbers.

### First Embodiment

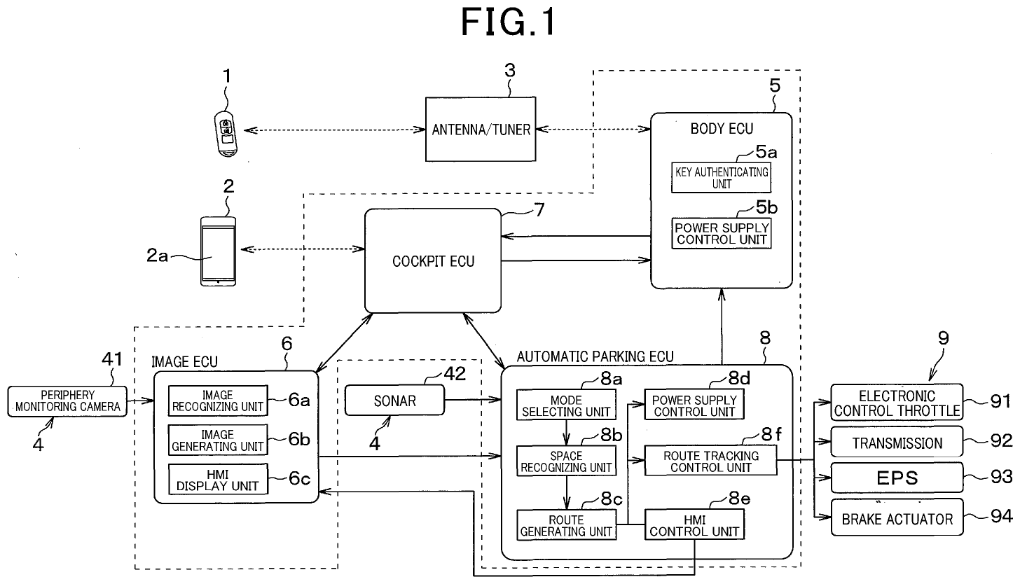

A remote parking system that includes a parking assistance control apparatus according to a present embodiment will be described below. As shown in FIG. 1, the remote parking system includes an electronic key 1, a remote controller 2, an antenna/tuner 3, a periphery monitoring sensor 4, various ECUs 5 to 8 that configure a control unit of the parking assistance control apparatus, and various actuators 9. As the various ECUs 5 to 8, a body ECU 5, an image ECU 6, a cockpit ECU 7, and an automatic parking ECU 8 are provided. These various ECUs 5 to 8, the antenna/tuner 3, the periphery monitoring sensor 4, and the various actuators 9 are communicably connected directly or by an in-vehicle local area network (LAN). The remote parking system performs remote parking based on remote control by an operator as parking assistance by controlling these sections. Here, parking assistance includes various types such as assistance in which a parking route is displayed and indicated, and assistance in which an announcement is made during parking. However, assistance related to various types of parking including remote parking is referred to as parking assistance herein

The electronic key 1 has authentication data for controlling an on/off state of a startup switch of a vehicle of the electronic key 1 itself (referred to, hereafter, as an own vehicle), such as opening/closing of a door and start/stop of an engine in the own vehicle. An operator of the own vehicle possesses the electronic key 1. Here, although referred to as an operator, the operator is typically the same person as a driver that drives the own vehicle. Specifically, the electronic key 1 is capable of performing wireless communication with the body ECU 5 through the antenna/tuner 3. The electronic key 1 receives a transmission request for the authentication data from the body ECU 5 and, when the transmission request is received, transmits the authentication data. In addition, the electronic key 1 is also capable of automatically locking and unlocking the door by transmitting a Lock/Unlock signal based on an operation by the operator.

The remote controller 2 is configured by a portable communication terminal, such as a smartphone or a tablet, and is an apparatus that can be carried outside the own vehicle. The remote controller 2 includes a touch-panel-type display screen 2a. The operator can perform an operation for remote parking and the like through the display screen 2a. The remote controller 2 transmits an operation signal that corresponds to the operation to the cockpit ECU 7. In addition, the remote controller 2 is also capable of communicating, to the cockpit ECU 7, position information of the remote controller 2 itself based on a Global Positioning System (GPS) and a camera image that is captured by a built-in camera.

For example, in the remote controller 2, an execution instruction for remote parking, a continuation instruction for remote parking, a stop instruction for remote parking, an image switching instruction, and the like can be issued. To give an example, when an application for remote parking is run through the display screen 2a of the remote controller 2, an execution button for remote parking is displayed. When the execution button is pressed, the execution instruction for remote parking is issued. In addition, when the execution button is continuously pressed, the continuation instruction for remote parking is issued. When pressing of the execution button is stopped, the stop instruction for remote parking is issued. An image switching button that is pressed when the operator wishes to display an image of a blind spot that is on a side opposite the operator relative to the own vehicle is also displayed on the display screen 2a. When the image switching button is pressed, the image switching instruction is issued.

The antenna/tuner 3 is provided to actualize wireless communication between the electronic key 1 and the body ECU 5. The antenna/tuner 3 transmits a signal that includes the transmission request that is communicated from the body ECU 5 to the electronic key 1, and receives a signal that includes the authentication data from the electronic key 1 and extracts the authentication data.

The periphery monitoring sensor 4 is an autonomous sensor that monitors a surrounding environment of the own vehicle. For example, the periphery monitoring sensor 4 may detect a solid object in the vehicle vicinity as a detection target object, the solid objects being a dynamic target object that moves, such as a pedestrian or another vehicle, and a stationary target object that is stationary, such as a structure on a road. Here, as the periphery monitoring sensor 4, a periphery monitoring camera 41 that captures an image of a predetermined area surrounding the own vehicle, and a sonar 42 that transmits a probe wave over a predetermined area surrounding the own vehicle are included. For example, when parking assistance is performed, each periphery monitoring sensor 4 may perform detection of a solid object at every control cycle that is determined for each periphery monitoring sensor 4

The periphery monitoring camera 41 corresponds to an imaging apparatus. The periphery monitoring camera 41 captures a peripheral image of the own vehicle and outputs imaging data of the peripheral image to the image ECU 6 as sensing information. Here, a case in which a front-side camera, a rear-side camera, a left-side camera, and a right-side camera that captures images ahead of, to the rear of, and to the left and right of the vehicle are included as the periphery monitoring camera 41 is described as an example. However, this is not limited thereto. As a result of the imaging data of the periphery monitoring camera 41 being analyzed, a “solid object” can be detected. Generation of an image to be displayed on the display screen 2a of the remote controller 2 during remote parking can be performed through use of the imaging data.

Here, the “solid object” refers to an object that has three-dimensional spatial extent, such as a solid structure, a person, or a bicycle, that is detected by the periphery monitoring sensor 4. An “obstacle” refers to a solid object, among the “solid objects,” that may become an obstacle to movement of the own vehicle when parking assistance control is performed. Even if a solid object is a “solid object,” a solid object that is not an obstacle to the movement of the own vehicle, such as a wall that is in a position higher than the own vehicle or a bump that is of a height that can be cleared, may not be included in “obstacles.”

The sonar 42 corresponds to a probe wave sensor. The sonar 42 outputs an ultrasonic wave as the probe wave at every predetermined sampling cycle. In addition, the sonar 42 successively outputs, to the automatic parking ECU 8, measurement results of a relative speed and a relative distance to a target object, and a position such as an orientation angle at which the target object is present that are acquired by a reflected wave of the ultrasonic wave being acquired, as the sensing information. When an object is detected, the sonar 42 includes detection coordinates that are coordinates of the detected position in the sensing information and outputs the sensing information. The detection coordinates of the object are identified using a moving triangulation method. A distance to the object changes in accompaniment with the movement of the own vehicle, and therefore, the detection coordinates of the object are identified based on changes in the measurement results at every sampling cycle.

Here, only a single sonar 42 is shown. However, in actuality, the sonar 42 is provided in a plurality of locations in the vehicle. For example, as the sonars 42, front sonars and rear sonars in which a plurality of sonars 42 are arranged in an array in a left/right direction of the vehicle in front and rear bumpers, and side sonars that are arranged in side positions of the vehicle can be used

Here, the sonar 42 is used as an example of the probe wave sensor. However, as the probe wave sensor, a millimeter-wave radar, light detection and ranging (LIDAR), and the like can also be used. The millimeter-wave radar performs measurement using a millimeter wave as the probe wave. The LIDAR performs measurement using laser light as the probe wave. For example, the millimeter-wave radar and the LIDAR may output the probe wave within a predetermined range ahead of the vehicle or the like, and perform measurement within the output range of the probe wave.

In addition, although the periphery monitoring sensor 4 that includes the periphery monitoring camera 41 and the sonar 42 is used as an example according to the present embodiment, periphery monitoring is merely required to be performed by at least the periphery monitoring camera 41, of the periphery monitoring camera 41 and the sonar 42, and not all need be provided.

The various ECUs 5 to 8 configure the control unit of the parking assistance control apparatus and are configured by a microcomputer that includes a central processing unit (CPU), a read-only memory (ROM), a random access memory (RAM), an input/output (I/O), and the like. The various ECUs 5 to 8 are described as a configuration that is divided into a plurality of ECUs according to the present embodiment. However, at least a portion of the various ECUs 5 to 8 may be configured by a single ECU, and at least a portion may be a configuration that is further divided into a plurality of ECUs. The control unit of the parking assistance control apparatus is configured by the various ECUs 5 to 8 in cooperation or by at least a portion of the ECUs 5 to 8.

The body ECU 5 is capable of performing communication with the electronic key 1 through the antenna/tuner 3, and communication with the automatic parking ECU 8, the cockpit ECU 7, and the like. The body ECU 5 performs key authentication to determine whether the electronic key 1 is an authentic electronic key of the own vehicle, based on communication with the electronic key 1. In addition, the body ECU 5 performs Lock/Unlock control of the door and control of the startup switch, such as an ignition switch, to set the own vehicle to a startup state in which the vehicle is able to run, based on a key authentication result.

In addition, at start of remote parking, the body ECU 5 receives an operation signal that indicates content of an operation for remote parking from the cockpit ECU 7 or the automatic parking ECU 8, and issues the transmission request for the authentication data to the electronic key 1. Then, the body ECU 5 turns on the startup switch when the electronic key 1 is an authentic electronic key of the own vehicle, based on the key authentication using the authentication data that is transmitted from the electronic key 1. According to the present embodiment, whether a mode is an execution mode in which parking assistance control is performed as described hereafter or a non-execution mode in which parking assistance control is not performed is sent to the body ECU 5 from the automatic parking ECU 8. The body ECU 5 only turns on the startup switch when the mode is the execution mode.

In addition, the body ECU 5 communicates the result of the key authentication to the cockpit ECU 7. As a result, in the cockpit ECU 7, the result of the key authentication is communicated to the remote controller 2, and an instruction for image generation to the image ECU 6 can be issued. Furthermore, an operation instruction for remote parking by an operation signal being sent to the automatic parking ECU 8 can be issued. Specifically, the body ECU 5 is configured to include a key authenticating unit 5a and a power supply control unit 5b as functional units that perform various types of control.

The key authenticating unit 5a stores therein identification information for collation, in advance. The key authenticating unit 5 performs the key authentication by collating the identification information for collation and the information that is sent from the electronic key 1, and confirms that the electronic key 1 is an authentic electronic key of the own vehicle. When the electronic key 1 is confirmed to be an authentic electronic key of the own vehicle as a result of the key authentication by the key authenticating unit 5a, the body ECU 5 performs the Lock/Unlock control that enables the door to be unlocked by the operator touching a door handle and the like.

The power supply control unit 5b performs control of an on/off state of the startup switch. For example, when the key authenticating unit 5a confirms that the electronic key 1 is an authentic electronic key of the own vehicle and a push switch that is provided inside a vehicle cabin is pressed, the power supply control unit 5b may turn on the startup switch and set the own vehicle to a ready-to-run state. In addition, the power supply control unit 5b receives a startup command signal that instructs that the startup switch be turned on and a stop command signal that instructs that the startup switch be tuned off as operation signals for remote parking from the cockpit ECU 7. Furthermore, the power supply control unit 5b receives information regarding whether a mode is the execution mode in which parking assistance control is performed or the non-execution mode in which parking assistance control is not performed from the automatic parking ECU 8. Then, when the startup command signal or the stop command signal is received, the power supply control unit 5b controls an on/off state of the startup switch if the electronic key 1 is confirmed as an authentic electronic key of the own vehicle by key authentication and information that the mode is the execution mode be received.

The image ECU 6 inputs the imaging data from the periphery monitoring camera 41, generates a peripheral image of the own vehicle, and generates a Human Machine Interface (HMI) display so as to overlap the peripheral image or separately from the peripheral image. For example, the image ECU 6 is capable of communicating with the cockpit ECU 7 and the automatic parking ECU 8, and generates an image that is appropriate for a situation based on data that is sent from the cockpit ECU 7 and the automatic parking ECU 8. Specifically, the image ECU 6 is configured to include an image recognizing unit 6a, an image generating unit 6b, and an HMI display unit 6c as functional units that perform various types of control.

The image recognizing unit 6a performs image recognition of the vicinity of the vehicle from the imaging data that is inputted from the periphery monitoring camera 41.

The image generating unit 6b generates the peripheral image of the own vehicle based on an image recognition result from the image recognizing unit 6a. For example, the image generating unit 6b may generate differing images between an image when the operator performs parking by driving by the operator themselves (hereafter, referred to as during ordinary parking), and during remote parking in which the operator performs remote parking using the remote controller 2. An image request is issued from the cockpit ECU 7 during remote parking, when the image request is received, and thus, the image generating unit 6b performs image generation during remote parking. In addition, when a request based on an operation of the remote controller 2 is received or when the automatic parking ECU 8 detects an obstacle based on a detection signal from the sonar 42 and issues an image switching request, the image recognizing unit 6a generates an image based on the request.

To give an example, during ordinary parking, the image generating unit 6b generates a top view image that is an image in which the own vehicle is viewed from directly above. In addition, during remote parking, while also performing generation of the top view image similar to that during ordinary parking, the image generating unit 6 generates a remote parking image that enables confirmation of a position on a side opposite the operator relative to the own vehicle, that is, a position of a blind spot, while viewing the direction of the own vehicle from a field of view on the operator side. Then, as a result of an image switching request, switching between the top view image and the remote parking image can be performed. These images that are generated by the image generating unit 6b will be described in detail hereafter.

The HMI display unit 6c generates an HMI display that reflects information that is sent based on HMI control from an HMI control unit 8e, described hereafter, that is provided in the automatic parking ECU 8 and obstacle information that indicates a detection result of an obstacle from the sonar 42 according to the present embodiment. For example, the HMI display may be an image in which information that indicates the detection result of an obstacle is superimposed onto an image that is generated by the image generating unit 6b. To give an example, as the information that indicates the detection result of an obstacle, a display of an obstacle in a location in which the obstacle is present or a distance display from a location of the own vehicle that is at a shortest distance from the obstacle towards the obstacle is superimposed onto the image that is generated by the image generating unit 6b.

The cockpit ECU 7 handles meter information, navigation information, vehicle information, multimedia information, and the like, and performs meter display by a meter apparatus, navigation display through a display of a navigation apparatus, and the like based on the various types of information that are handled.

In addition, the cockpit ECU 7 is capable of communicating with the body ECU 5, the image ECU 6, and the automatic parking ECU 8, as well as the remote controller 2. Therefore, the cockpit ECU 7 issues an image request or an image switching request to the image ECU 6, receives image data that is sent from the image ECU 6, and communicates the image data to the remote controller 2 and the display of the navigation apparatus. Furthermore, the cockpit ECU 7 receives position information, camera image information, and the like from the remote controller 2, in addition to the operation signal for remote parking from the remote controller 2, and transmits a vehicle state and generated image information to the remote controller 2.

In addition, the cockpit ECU 7 detects a position in which the operator who possesses the remote controller 2 is present relative to the own vehicle based on the position information that is sent from the remote controller 2 and position information of the own vehicle that is detected based on GPS. As a result, the cockpit ECU 7 ascertains an orientation of the own vehicle from the position of the operator, an orientation of a blind spot that is hidden by the own vehicle, and a blind spot position. Then, when the orientation of the own vehicle from the position of the operator, the orientation of the blind spot that is hidden by the own vehicle, and the blind spot position are ascertained, the cockpit ECU 7 request an image of when the blind spot position is viewed by the operator, during the image request for the remote parking image. That is, cockpit ECU 7 issues an image request that includes data for identifying an orientation and a display area of an image that is used by the image ECU 6 to generate the remote parking image.

Moreover, the cockpit ECU 7 communicates to the automatic parking ECU 8 that an operation signal that indicates the start of remote parking is received, and receives the information that is related to whether a mode is the execution mode in which remote parking is performed or the non-execution mode in which remote parking is not performed from the automatic parking ECU 8. In addition, when an operation signal that indicates that remote parking is performed is received from the remote controller 2, the cockpit ECU 7 performs communication with the body ECU 5 and causes the body ECU 5 to perform key authentication. The cockpit ECU 5 also receives the result of the key authentication. Then, when the electronic key 1 is an authentic electronic key of the own vehicle, the cockpit ECU 7 issues an image request to the image ECU 6 based on the operation signal from the remote controller 2 that indicates the remote parking is performed, and communicates content of an operation during remote parking to the automatic parking ECU 8.

Furthermore, when an operation to request image switching is performed in the remote controller 2 during remote parking, the cockpit ECU 7 issues the image switching request to the image ECU 6. In addition, the cockpit ECU 7 acquires the obstacle information from the automatic parking ECU 8, and issues the image switching request even in cases in which a likelihood of the operator not being able to recognize the obstacle is present, such as when the obstacle is present in a position of a blind spot or when the obstacle is approaching a position of a blind spot.

During parking assistance including remote parking, the automatic parking ECU 8 inputs the sensing information that is composed of the detection result from the periphery monitoring sensor 4 and the measurement result from the sonar 42, and performs various types of control for parking assistance based on the sensing information. Parking assistance is performed when an instruction to perform parking assistance is issued, such as when a parking assistance switch (not shown) that is pressed by the driver when parking assistance is to be performed is pressed or when an instruction for remote parking is issued from the remote controller 2.

When the instruction for parking assistance is issued, the automatic parking ECU 8 recognizes a free space in which parking is possible based on the sensing information from the periphery monitoring sensor 4. The automatic parking ECU 8 also generates a parking route from a current position of the own vehicle to a parking intended position during automatic parking and performs route tracking control along the parking route. Specifically, the automatic parking ECU 8 is configured to include a mode selecting unit 8a, a space recognizing unit 8b, a route generating unit 8c, a power supply control unit 8d, an HMI control unit 8e, and a route tracking control unit 8f as functional units that perform various types of control.

The mode selecting unit 8a performs mode selection of whether a mode is the execution mode in which parking assistance control is performed or the non-execution mode in which parking assistance control is not performed. For example, when the parking assistance switch is pressed when parking by driving by the operator is performed, a state check regarding whether the periphery monitoring camera 41 and the sonar 42 are functional and the like may be performed. Then, when parking assistance can be performed, the execution mode is selected. When parking assistance cannot be performed, the non-execution mode is selected.

In addition, in cases in which the driver disembarks from the own vehicle and performs remote parking of the own vehicle through the remote controller 2, rather than by driving by the operator, as well, the above-described state check is performed. When parking assistance can be performed, the execution mode is selected. When parking assistance cannot be performed, the non-execution mode is selected. When the mode selecting unit 8a performs the mode selection, the selected mode is communicated to the body ECU 5 from the power supply control unit 8d. Then, if the execution mode is selected, the power supply control unit 5b turns on the startup switch, and various types of calculations and various types of control by the other functional units of the automatic parking ECU 8 are performed.

The space recognizing unit 8b inputs the sensing information from the periphery monitoring sensor 4 and performs recognition of a surrounding environment of the own vehicle in which parking is to be performed, specifically recognition of a solid object that is present in the vicinity of the own vehicle, based on the sensing information. In addition, the space recognizing unit 8b performs free space recognition for parking the own vehicle based on the recognition result of a solid object.

Specifically, the space recognizing unit 8b inputs the imaging data from the periphery monitoring camera 41 and the measurement result by the probe waves of the sonar 42 as the sensing information, and performs solid object recognition based on image analysis of the imaging data and the measurement result by the probe waves. In the solid object recognition, a solid object that is present in the own vehicle vicinity, such as a dynamic target object or a stationary target object, is recognized as a detection target object. Route generation, described hereafter, is performed based on a shape and the like of an obstacle, preferably a stationary target object, among the solid objects that are the detection target objects recognized in the solid object recognition. In addition, determination regarding the presence/absence of an obstacle and the like are also performed.

The imaging data that is inputted from the periphery monitoring camera 41 is imaging data that shows a state surrounding the periphery monitoring camera 41. Therefore, the presence/absence of a solid object can be recognized by the image being analyzed. In addition, whether the solid object is a dynamic target object or a stationary target object can be identified, and a position of the solid object, that is, a position, a distance, and a height of the solid object relative to the own vehicle can be detected, based on a shape of the recognized object or an optical flow of the image.

Furthermore, the presence/absence of a solid object, and the position and the distance of the solid object can be detected, and whether the solid object is a dynamic target object or a stationary target object can be identified from the sensing information of the sonar 42 as well. Here, the space recognizing unit 8b performs the solid object recognition based on both the analysis of the image data from the periphery monitoring camera 41 and the measurement result by the probe waves of the sonar 2. However, the solid object recognition can be performed even based on only either thereof. However, through use of both, a more accurate solid object recognition can be performed.

In addition, the space recognizing unit 8b performs free space recognition in which a location that is a free space is recognized from a parking area that is shown in the imaging data from the periphery monitoring camera 41, using the result of the solid object recognition, described above. The free space is a location in the parking area in which another vehicle is not parked and refers to a parking space that has an area and a shape in which the own vehicle can be parked. This is not limited a case in which a plurality of parking spaces are present in the parking area and also includes a case in which only a single parking space is present. The location that is recognized as the free space is set as the parking intended position.

Furthermore, when an obstacle is recognized based on the measurement result from the sonar 42, the space recognizing unit 8b communicates the obstacle information that is the information related to the obstacle, such as the position of the obstacle and the shape of the obstacle, to the cockpit ECU 7. As a result, the cockpit ECU 7 can recognize that the likelihood that the operator not being able to recognize the obstacle is present, such as the obstacle being present in a position of a blind spot.

The route generating unit 8c performs route generation based on the results of the solid object recognition and the free space recognition, and performs a target vehicle speed generation that corresponds to the parking route. Specifically, the route generating unit 8c calculates a movement route from the current position of the own vehicle to the parking intended position that is recognized by the free space recognition, while avoiding the obstacle that is recognized by the solid object recognition, and generates a route that is indicated by the calculation result as the parking route.

In addition, when a limiting condition of some kind is present when route generation is performed, the route generating unit 8c generates the parking route to meet the limiting condition. For example, the route generating unit 8c may generate the parking route such that multiple-point turns are minimize within a predetermined area. In addition, when a limiting condition is present regarding an orientation during parking, that is, an entry direction into the parking intended position, the parking route is calculated with this limiting condition included in the limiting conditions. For example, in a case of forward parking in which the own vehicle is parked by being moved forward into the parking intended position, or in a case of reverse parking in which the own vehicle is parked by being moved backwards into the parking intended position, this orientation of the own vehicle during parking may be a limiting condition.

Regarding the orientation of the own vehicle during parking, in a case in which the imaging data of the periphery monitoring camera 41 includes a sign in which information such as “forward parking” or “reverse parking” is written, or includes a mark that indicates the orientation during parking or the like, the information is included in the limiting conditions. Furthermore, when a setting switch by which a user sets the orientation of the own vehicle during parking or the like is present, the orientation of the own vehicle during parking can be included in the limiting conditions based on a setting state of the setting switch.

Here, the parking route is generated so as to avoid an obstacle configured by a solid object recognized by the solid object recognition is avoided. However, the parking route is generated so as to avoid only the stationary target object among the obstacles. The dynamic target object moves. Thus, after danger of collision with the dynamic target object is no longer present, the own vehicle may be moved. In this case, it is sufficient that the parking route is generated taking into consideration only the stationary target object.

In addition, the route generating unit 8c sets the target vehicle speed at each section of the route when the own vehicle is moved along the calculated parking route. Various setting methods for the target vehicle speed can be considered. For example, the target vehicle speed may be determined by a fixed vehicle speed being set or an upper-limit control vehicle speed based on a turning radius being provided.

When the mode selecting unit 8a performs the mode selection, the power supply control unit 8d communicates the selected mode to the body ECU 5 so as to cause the power supply control unit 5b of the body ECU 5 to control an on/off state of the startup switch based on the mode selection.

The HMI control unit 8e performs HMI control to generate an image that reflects the sensing information from the sonar 42 in the HMI display unit 6c of the image ECU 6. For example, the HMI control unit 8e may send, to the HMI display unit 6c, information that indicates the location in which the obstacle is present, information that indicates the distance to the obstacle from a location of the own vehicle at the shortest distance from the obstacle, and the like as the obstacle information, based on the sensing information of the sonar 42.

The route tracking control unit 8f is a section that performs route tracking control by performing vehicle motion control, such as acceleration/deceleration control and steering control of the own vehicle. The route tracking control unit 8f outputs control signals to the various actuators 9 such that the own vehicle can be moved so as to track the parking route and the target vehicle speed that are generated by the route generating unit 8c and parked in the parking intended position. Here, the automatic parking ECU 8 is configured by a single ECU and the configuration is such that the route tracking control unit 8f is provided within the ECU. However, the automatic parking ECU 8 may be configured by a combination of a plurality of ECUs, and the route tracking control unit 8f may be configured by these ECUs. For example, as the plurality of ECUs, a steering ECU that performs steering control, a power unit control EUC that performs acceleration/deceleration control, a brake ECU, and the like can be used.

Specifically, the route tracking control unit 8f acquires detection signals that are outputted from sensors, such as an accelerator position sensor, a brake depression sensor, a steering angle sensor, a wheel speed sensor, a shift position sensor, and the like that are mounted in the vehicle but not shown in the drawings. Then, the route tracking control unit 8f detects a state of each section by the acquired detection signals and outputs the control signals to the various actuators 9 to move the own vehicle so as to track the parking route and the target vehicle speed.

The various actuators 9 are various traveling control devices related to traveling and stopping of the own vehicle. The various actuators 9 include an electronic control throttle 91, a transmission 92, an electric power steering (EPS) motor 93, a brake actuator 94, and the like. These various actuators 9 are controlled based on the control signals from the route tracking control unit 8f, and a traveling direction, a steering angle, a brake/drive torque of the own vehicle are controlled. Consequently, parking assistance control that includes route tracking control in which the own vehicle is moved based on the parking route and the target vehicle speed, and parked in a parking intended position Pb is implemented.

Here, when the own vehicle is moved from the current position to the parking intended position, the own vehicle may be moved so as to track the route. However, a person or another vehicle may approach the own vehicle during the movement of the own vehicle. In this case, the own vehicle is prevented from colliding with the dynamic target object by the movement of the own vehicle being stopped until the dynamic target object moves outside an area of a movement intended trajectory of the own vehicle that is estimated from the parking route and a vehicle width. In addition, a case is also possible in which a stationary target object is present that is not able to be recognized when the parking route is initially calculated. Therefore, the solid object recognition by the space recognizing unit 8b is continued even while the own vehicle is moving so as to track the parking route. Then, if a stationary target object is present in a location in which a collision may occur when the own vehicle moves so as to track the parking route, regeneration of the parking route is performed.

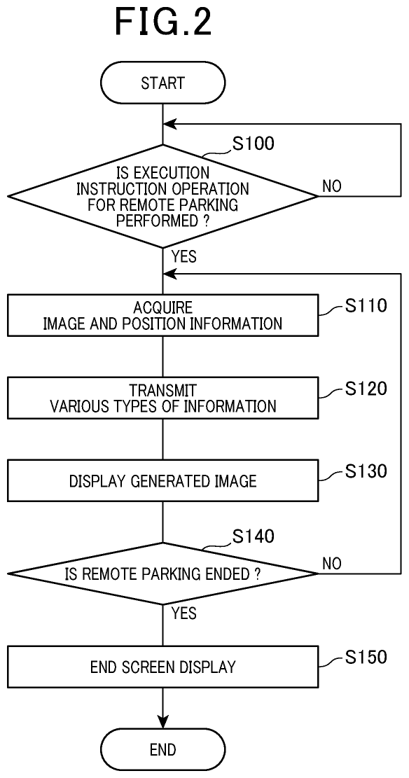

The remote parking system according to the present embodiment is configured as described above. Next, operations of the remote parking system configured in this manner will be described with reference to FIG. 2 to FIG. 5. The remote parking system also performs various types of control other than remote parking by the various ECUs 6 to 8. For example, the remote parking system may also perform parking assistance in cases in which the operator performs parking based on their own driving. However, the operations of the remote parking system will be described with focus on remote parking herein.

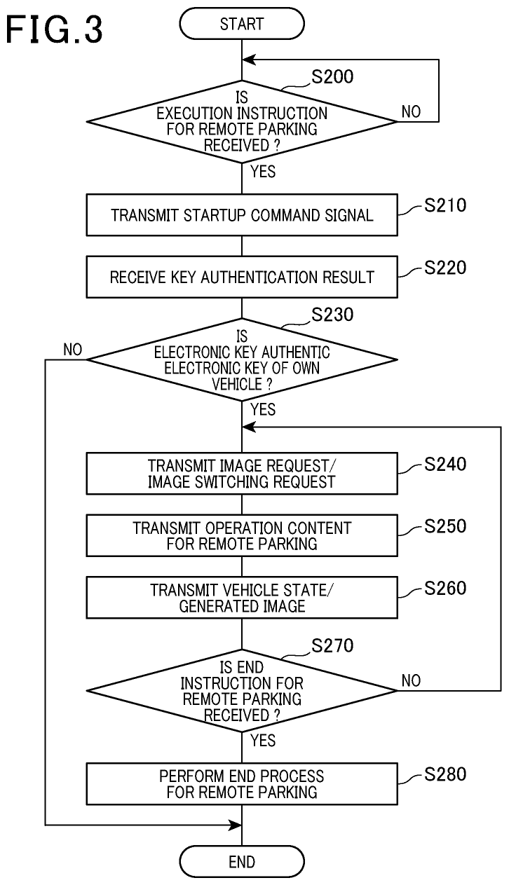

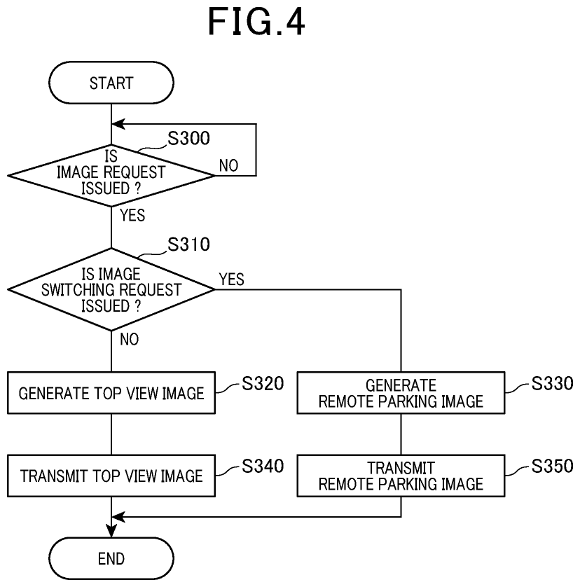

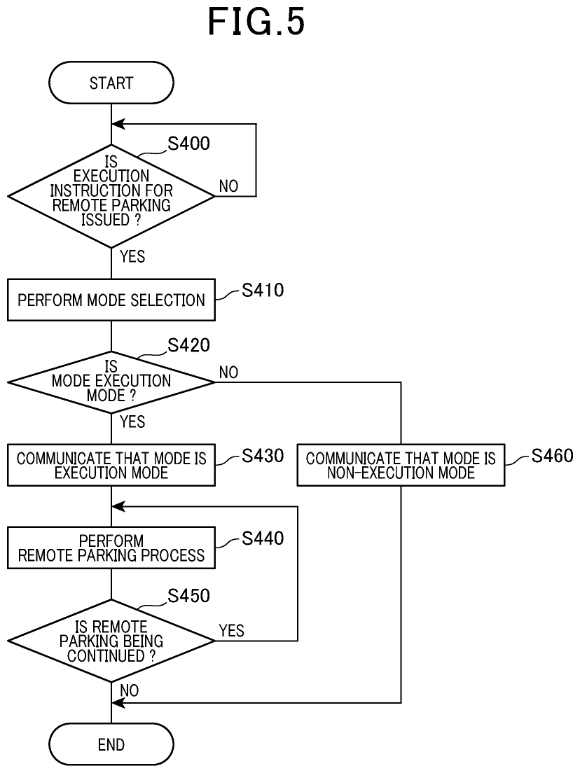

FIG. 2 is a flowchart of an operation control process that is performed by the remote controller 2. FIG. 3 is a flowchart of a control process that is performed by the cockpit ECU 7. In addition, FIG. 4 is a flowchart of image processing that is performed by the image ECU 6. FIG. 5 is a flowchart of an automatic parking process that is performed by the automatic parking ECU 8. The processes shown in the flowcharts in these drawings are performed by the ECUs at every predetermined control cycle. Here, the processes are performed when the startup switch is turned off during vehicle stopping in which remote parking is expected to be performed. However, the processes may be performed when the startup switch is turned on.

First, in the remote controller 2, as shown in FIG. 2, at step S100, whether an operation that instructs execution of remote parking is performed is determined. For example, when the operator runs the application for remote parking through the display screen 2a of the remote controller 2, the execution button for remote parking may be displayed. When the execution button is pressed, the remote controller 2 determines that the instruction for execution of remote parking is issued.

At subsequent step S110, the camera image information is acquired by a camera image that faces the own vehicle side being captured using an built-in camera of the remote controller 2. In addition, the position information is acquired based on GPS. Then, at step S120, a process to transmit, to the cockpit ECU 7, the camera image information and the position information acquired at step S110, together with the operation signal that indicates the content of the operation for remote parking is performed by wireless communication. When remote parking is started, as the content of the operation for remote parking, the execution instruction for remote parking is communicated to the cockpit ECU 7 from the remote controller 2.

When remote parking is performed based on the execution instruction for remote parking, at step S130, the generated image information of the image ECU 6 that is sent from the cockpit ECU 7 is received, and image display that is indicated by the generated image information is performed. Then, the process proceeds to step S140, and whether remote parking is ended is determined. The processes at steps S110 to S130 are repeated until an affirmative determination is made.

For example, the execution button and the image switching button may be displayed in a location that does not obstruct image display, such as any of four corners of the display screen 2a. Then, when the operator continues to press the execution button, at step 120, remote parking is continued by information that indicates that remote parking is continued being continuously transmitted as the operation signal. At step S130, the image display during remote parking is continued. In addition, when the execution button is released, remote parking is stopped. However, when the execution button is pressed again, the information that indicates that remote parking is continued is continuously transmitted again.

Furthermore, when the operator presses the image switching button, at step S120, a signal that indicates image switching is transmitted as the operation signal. At step S130, display switching between the top view image and the remote parking image is performed. Then, when a signal that indicates that the own vehicle has reached the parking intended position by remote parking is sent from the automatic parking ECU 8 to the cockpit ECU 7, or the operator issues an end instruction for remote parking through the remote controller 2, at step S140, the remote parking is determined to have ended. When the end of remote parking is determined in this manner, the process proceeds to step S150. Screen display during remote parking is ended and the process is ended.

Meanwhile, on the own vehicle side, as shown in FIG. 3, at step S200, the cockpit ECU 7 determines whether the operation signal for remote parking, that is, the execution instruction for remote parking is received. Therefore, when the execution instruction for remote parking is transmitted from the remote controller 2 at step S120 in FIG. 2, an affirmative determination is made at step S200. Then, the process proceeds to step S210. A startup command signal that corresponds to the execution instruction for remote parking is communicated to the body ECU 5, and the execution instruction for remote parking is sent as the operation signal for remote parking to the automatic parking ECU 8.

As a result, the mode selecting unit 8a performs mode selection regarding whether a mode is the execution mode or the non-execution mode, and the selection result is communicated to the body ECU 5. Then, the transmission request for authentication data is transmitted from the body ECU 5 to the electronic key 1. When the authentication data is returned from the electronic key 1 to the body ECU 5, the key authenticating unit 5a performs key authentication. The result of the key authentication is communicated to the cockpit ECU 7. In addition, when, as a result of the key authentication, the electronic key 1 is an authentic electronic key of the own vehicle and the mode that is communicated from the automatic parking ECU 8 is the execution mode, the power supply control unit 5b turns on the startup switch of the own vehicle.

Furthermore, after receiving the key authentication result at step S220, at step S230, the cockpit ECU 7 determines whether the electronic key 1 is an authentic electronic key based on the received key authentication result. When a negative determination is made herein, the process is ended because the execution instruction for remote parking is not issued to the own vehicle. When an affirmative determination is made, the process proceeds to step S240.

At step S240, the image request or the image switching request is issued to the image ECU 6. In addition, the process proceeds to step S250 and the operation signal that indicates the content of the operation for remote parking is sent to the automatic parking ECU 8. Based on the content of the operation for remote parking, an image request is issued while the execution instruction or the continuation instruction for remote parking is being issued. The image switching request is also issued at a timing when the image switching button is pressed. Furthermore, the image switching request is also issued when the obstacle is present in a position of a blind spot based on the obstacle information that is communicated from the automatic parking ECU 8 to the cockpit ECU 7, and the like.

When the processes at these steps S240 and S250 are performed, the image ECU 6 and the automatic parking ECU 8 perform various processes. Then, the process proceeds to step S260. When the generated image information is acquired from the image ECU 6, the generated image information, together with the vehicle state information, is transmitted from the cockpit ECU 7 to the remote controller 2. The processes at these steps S240 to S260 are continued until the end instruction for remote parking is determined to be received at step S270.

Here, when the own vehicle reaching the parking intended position by remote parking is communicated from the automatic parking ECU 8 or the operator performing the operation for the end instruction for remote parking is communicated from the remote controller 2 to the cockpit ECU 7, an affirmative determination is made at step S270. In this case, the process proceeds to step S280 and the end process for remote parking is performed. As a result, for example, a signal that indicates the end instruction for remote parking may be outputted from the cockpit ECU 7 to the body ECU 5, the image ECU 6, and the automatic parking ECU 8. The body ECU 5 turns off the startup switch and the ECUs 6, 7, and 8 also end the processes.

When the image request or the image switching request is issued at step S240 in FIG. 3, in the image ECU 6, a process for performing image generation based on the request is performed. First, at step S300 in FIG. 4, whether the image request is issued is determined. When the image request is issued, processes at step S310 and subsequent steps are performed.

At step S310, whether the image switching request is issued is determined. When the operator performs an operation for image switching through the remote controller 2 or the automatic parking ECU 8 detects an obstacle based on the detection signal from the sonar 42, the image switching request is issued from the cockpit ECU 7. In addition, when, after the operator performs the operation for image switching through the remote controller 2, the operator performs an operation to return to the original image again, the state becomes a state in which the image switching request is not made. Here, when a negative determination is made, the process proceeds to step S320. When an affirmative determination is made, the process proceeds to step S330.

At step S320, the imaging data from the periphery monitoring camera 41 is acquired and a top view image is generated. As described above, the front-side camera, the rear-side camera, the left-side camera, and the right-side camera that capture images to the front, rear, and left and right sides of the vehicle are present as the periphery monitoring camera 41. Therefore, the imaging data from the periphery monitoring cameras 41 are combined and the top view image is generated. Subsequently, the process proceeds to step S340 and the top view image is communicated to the cockpit ECU 7. As a result, top view image information is transmitted from the cockpit ECU 7 as the generated image information at step S260 in FIG. 3. The top view image is displayed through the display screen 2a of the remote controller 2. In this manner, when the image switching request is not issued, as a result of the top view image that is performed even when the operator parks by driving the own vehicle being displayed, the state of remote parking can be confirmed.

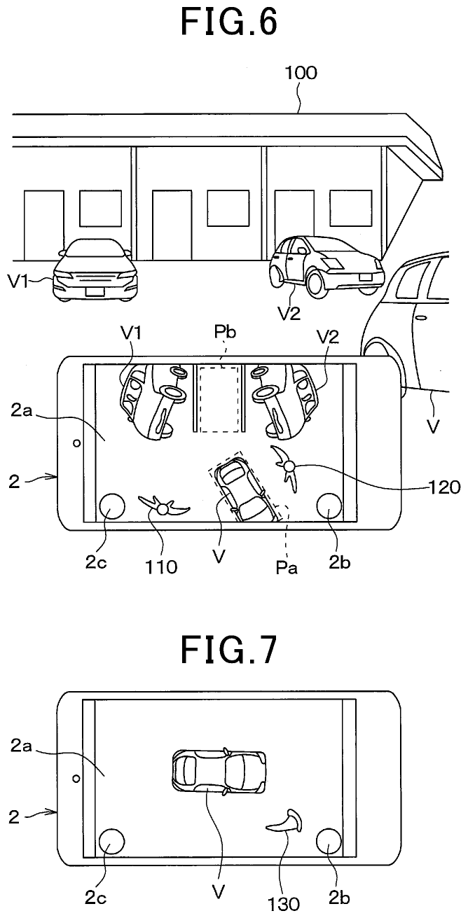

Here, the top view image will be described. The top view image is an image in which the own vehicle is viewed from directly above, as described above. For example, FIG. 6 shows a situation in which, when parallel parking spaces are provided in front of a building 100, two vehicles V1 and V2 are parked in a row with a single free space therebetween. In this situation, an own vehicle V that is present towards a front right side of an operator 110 is being remotely parked in the free space that is the parking intended position Pb from a current position Pa.

In this case, as shown on the display screen 2a of the remote controller 2 shown in FIG. 6, an image in which the own vehicle V is viewed from directly above and the own vehicle V is positioned near a center of the image is the top view image. The top view image may be displayed such that any direction is in an image upper position on the display screen 2a with the own vehicle V at the center. However, to facilitate recognition by the operator 110, a direction opposite the operator 110 who is holding the remote controller 2 relative to the own vehicle V is preferably displayed in the image upper position.

Here, an execution button 2b for remote parking is arranged in a lower right of the display screen 2a in FIG. 6 and an image switching button 2c is arranged in a lower left. For example, as a result of the execution button 2b being continuously pressed, remote parking may be continued. When the execution button 2b is released, remote parking is stopped. In addition, switching between the top view image and the remote parking image can be performed by the screen switching button 2c being pressed.

Meanwhile, at step 330, the imaging data from the periphery monitoring camera 41 is acquired and a remote parking image is generated. In the image request that is sent from the cockpit ECU 7, data for identifying the orientation and the display area of the image that is used to generate the remote parking image is included. Therefore, the image ECU 6 generates the remote parking image based on the data. The remote parking image is also generated using the imaging data from the periphery monitoring cameras 41 and by the imaging data from a plurality of periphery monitoring cameras 41 being combined as required. At this time, as a result of the periphery monitoring camera 41 that captures a blind spot position being selected based on the position of the remote controller 2, the position of the own vehicle V, and the orientation of the own vehicle V that is indicated in the vehicle information, the periphery monitoring camera 41 of which the imaging data is to be used is determined.

Here, details of the remote parking image will be described. The remote parking image is an image for enabling the operator 110 to accurately ascertain a situation in a position of a blind spot of the own vehicle V that is difficult to ascertain by the top view image. The above-described top view image is an image in which the own vehicle V is positioned near the image center as shown in FIG. 6. Therefore, in the top view image as well, the position of the blind spot of the own vehicle V is also shown in the image. However, the top view image is generated by an image in which an imaging center axis is substantially oriented in a horizontal direction being captured using the periphery monitoring camera 41 in which an optical system is a fisheye lens or the like, and viewpoint conversion being performed on the captured image. Therefore, as a result of the vehicles V1 and V2, an obstacle 120, and the like in the vicinity of the own vehicle V being displayed in an image that has distortion, the operator 110 is not able to accurately ascertain a distance relationship between the own vehicle V, and the other vehicles V1 and V2 and the obstacle 120.

For example, as shown in FIG. 6, the vehicles V1 and V2 that are stopped on both sides of the free space may be displayed in distorted form on the display screen 2a, and may be displayed so as to be larger compared to the own vehicle V. This is clear when a case in which a parking cone 130 is present near the own vehicle V, as shown in FIG. 7, is confirmed. Although the parking cone 130 should normally be an image in which a conical shape is viewed from above, in the top view image, the parking cone 130 appears to be viewed from obliquely above and is in a distorted state. Therefore, in the top view image, the operator 110 cannot accurately ascertain the distance relationship between the own vehicle V, and the obstacle 120 and the like.

Therefore, according to the present embodiment, as the remote parking image, a see-through image that is an image in which the direction of the own vehicle V is viewed from the operator 110, and an image in which the own vehicle V is transparent and a blind spot that is positioned on the side opposite the operator 110 relative to the vehicle V is shown is generated. The see-through image is an image in which the own vehicle is viewed from a direction that is substantially along the horizontal direction from near a viewpoint of the operator, rather than an image in which the own vehicle V is viewed from directly above.

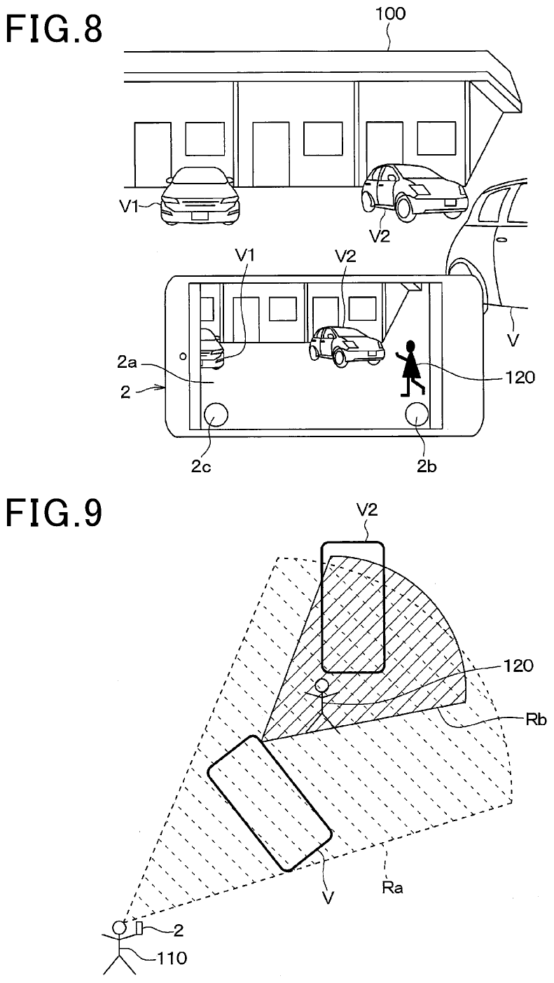

The see-through image may be formed by only the imaging data from the periphery monitoring cameras 41. Alternatively, the see-through image can be formed by the camera image information that is communicated from the remote controller 2 and the imaging data from the periphery monitoring camera 41 being combined. FIG. 8 shows an example of the remote parking image in a situation that is identical to that in FIG. 6. This drawing is a transparent image in which the own vehicle V is removed from the image to show the blind spot.

The see-through image is preferably an image that is viewed from a height of the viewpoint of the operator 110. However, the see-through image may also be an image that is viewed from a predetermined height that is determined in advance. When the see-through image is an image that is viewed from the viewpoint of the operator 110, a height of the remote controller 2 can be estimated as the viewpoint of the operator 110. For example, when the remote controller 2 is a smartphone or the like, a height-above-ground estimation function may be provided. The height of the remote controller 2 can be measured using the height-above-ground estimation function. In addition, the periphery monitoring camera 41 that can capture the operator 110 can be identified from the position of the remote controller 2, the position of the own vehicle, and the orientation of the own vehicle that is indicated by the vehicle information. Therefore, the height of the viewpoint of the operator 110 may be measured by the imaging data from the periphery monitoring camera 41 being analyzed.

In addition, the see-through image is an image in which a straight line that connects the operator 110 and a blind-spot center position is oriented in a depth direction of the display screen 2a. However, the see-through image may be an image in which the straight line has an angle, such as in the horizontal direction, relative to the depth direction. Furthermore, the straight line may be positioned in the center of the display screen 2a. Alternatively, the straight line may be positioned in a direction opposite the free space relative to the center of the display screen 2a, such that the free shape that is to be the parking intended position is displayed within the display screen 2a. Here, the blind-spot center position is prescribed based on a position on an extension line that connects the operator and the vehicle position, or the detected obstacle position.

In addition, regarding the remote parking image, when information that is sent from the HMI control unit 8e of the automatic parking ECU 8 based on HMI control is present, the remote parking image may be an image in which the information is reflected. For example, in the remote parking image, as information that indicates the detection result of the obstacle 120, an emphasized display of the obstacle 120 or the like may be superimposed onto the location in which the obstacle 120 is present in the remote parking image. As a result, in the blind spot position as well, the operator 110 can more accurately recognize the distance from the vehicle V to the obstacle 120.

Then, when the remote parking image is generated at step S330, the process proceeds to step S350. The remote parking image is transmitted to the cockpit ECU 7 and the process is ended. As a result, remote parking image information is transmitted from the cockpit ECU 7 as the generated image information at step S260 in FIG. 3, and the remote parking image is displayed on the display screen 2a of the remote controller 2. In this manner, when the image switching request is issued, as a result of the remote parking image being displayed instead of the top view image, the position of the blind spot can also be accurately ascertained.

Furthermore, in the automatic parking ECU 8, when the operation signal that indicates the content of the operation for remote parking is received, at step S400 in FIG. 5, whether the operation signal indicates the execution instruction for remote parking is determined. When an affirmative determination is made herein, the process proceeds to step S410 and a mode selection process is performed. In the mode selection process, mode selection of whether the mode is the execution mode in which the parking assistance control is performed or the non-execution mode in which the parking assistance control is not performed is performed. For example, a state check of the periphery monitoring camera 41 and the sonar 42 may be performed. When the driving assistance can be performed, the execution mode is selected. When the driving assistance cannot be performed, the non-execution mode is selected.

Subsequently, the process proceeds to step S420, and whether the mode that is selected in the mode selection process is the execution mode is determined. Then, when the mode is the execution mode, the process proceeds to step S430. After the mode being the execution mode is communicated to the body ECU 5, the process proceeds to step S440 and a remote parking process is performed as the parking assistance. In the remote parking process, recognition of a solid object and detection of an obstacle by the space recognizing unit 8b, free space recognition, route generation, and route tracking control are performed.

Then, as a result of the route tracking control, control signals are outputted to the various actuators 9, and the various actuators 9 are controlled such that the own vehicle V is moved so as to follow the parking route and the target vehicle speed that are generated in route generation, and parked in the parking intended position. In addition, when HMI control is performed at this time and an obstacle is detected, the obstacle information that is the detection result thereof is successively transmitted to the image ECU 6. Furthermore, when the obstacle is detected based on the detection signal from the sonar 42, the obstacle being detected is communicated from the automatic parking ECU 8 to the cockpit ECU 7, and the cockpit ECU 7 issues the image switching request.

Then, the process proceeds to step S450, and whether remote parking is being continued is determined. When remote parking is being continued, the process at step S440 is continuously performed. In addition, when remote parking is not being continued, for example, when the operator 110 issues the stop instruction for remote parking through the remote controller 2 or when the vehicle V arrives at the parking intended position Pb by remote parking, the process may be ended.

Meanwhile, when a negative determination is made at step S420, that is, when the non-execution mode is selected in the mode selection, the process proceeds to step S460 and the mode being the non-execution mode is communicated to the body ECU 5. In this case, remote parking cannot be performed, and thus, the process is immediately ended.

As described above, according to the present embodiment, the image that shows the blind spot that is hidden by the own vehicle V is generated as the remote parking image, and the remote parking image is displayed in the display screen 2a instead of the top view image. Specifically, the see-through image that is an image in which the direction of the own vehicle V is viewed from the operator 110, and an image in which the own vehicle V is transparent and a blind spot that is positioned on the side opposite the operator 110 relative to the vehicle V is shown serves as the remote parking image.

Therefore, the state in which the obstacle 120 is viewed from the operator 110 can be displayed on the display screen 2a as an image, and the operator 110 can accurately ascertain the distance relationship between the own vehicle V and the obstacle 120.

In addition, when the obstacle 120 is detected during remote parking, the image can also be an image in which the detection of the obstacle 120 is reflected. For example, the image can be an image win which, as the information that indicates the detection result of the obstacle 120, a display of the obstacle 120 in the location in which the obstacle 120 is present is superimposed onto the remote parking image. As a result, the operator 120 can more accurately recognize the distance from the own vehicle V to the obstacle 120 even in a blind spot position. Safety monitoring can be more accurately performed.

### Second Embodiment

A second embodiment will be described. In the present embodiment, the remote parking image is modified from that according to the first embodiment. The second embodiment is similar to the first embodiment in other respects. Therefore, only sections that differ from those according to the first embodiment will be described.

According to the first embodiment, the remote parking image is the see-through image. However, according to the present embodiment, the remote parking image is an own-vehicle viewpoint image. The own-vehicle viewpoint image refers to a screen in which a blind spot position is displayed as an image in a direction along a line of sight from a blind-spot-position side of the own vehicle V on a straight line that connects the operator 110 and the blind-spot center position. FIG. 9 shows display areas of the see-through image and the own-vehicle viewpoint image. As shown in the drawing, the see-through image is an image when the blind spot is viewed from the viewpoint of the operator 110. Therefore, the image is of a relatively wide area such as an area Ra that is indicated by broken-line hatching in the drawing. Meanwhile, the own-vehicle viewpoint image is an image when the blind spot is viewed from the blind-spot-position side of the own vehicle V. Therefore, while the own-vehicle viewpoint image is an image of a relative narrow area such as an area Rb that is indicated by solid-line hatching in the drawing, the own-vehicle viewpoint image is an image in which the narrow area is displayed in an enlarged manner.

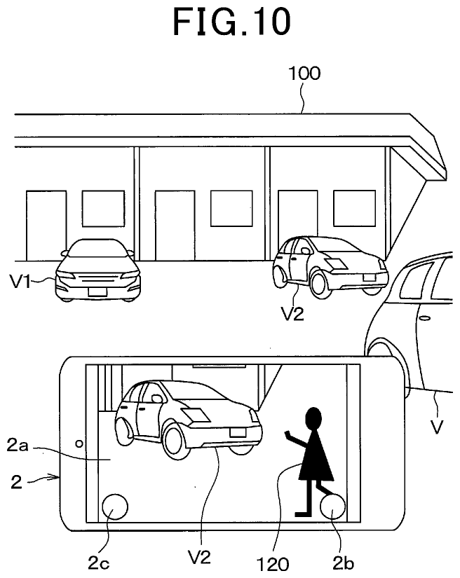

To give an example, the own-vehicle viewpoint image is an image such as that shown in FIG. 10, and is an image that is likely visible when the blind spot position is viewed from the blind-spot-position side of the own vehicle V that is the side opposite the operator 110. In a manner similar to the see-through image, the own-vehicle viewpoint image is also an image in which the straight line that connects the operator 110 and the blind-spot center position is oriented in the depth direction of the display screen 2a.

However, the own-vehicle viewpoint image may be an image which the straight line has an angle in the horizontal direction or the like relative to the depth direction. The own-vehicle viewpoint image is also preferably an image that is viewed from the height of the viewpoint of the operator 110, but may be an image that is viewed from a predetermined height that is determined in advance. In addition, the own-vehicle viewpoint image can also be an image that is formed by only the imaging data from the periphery monitoring cameras 41. Alternatively, the own-vehicle viewpoint image can also be formed by the camera image information that is communicated from the remote controller 2 and the imaging data from the periphery monitoring camera 41 being combined.

In this manner, the remote parking image can be the own-vehicle viewpoint image rather than the see-through image. As a result of the remote parking image being the own-vehicle viewpoint image such as this, a state in which the blind spot is directly viewed from the own vehicle V can be shown. Therefore, the operator 110 can recognize the state of the blind spot as an image that is further enlarged.

### Other Embodiments

While the present disclosure has been described with reference to embodiments described above, the disclosure is not limited to the above embodiments. The present disclosure is intended to cover various modification examples and modifications within the range of equivalency. In addition, various combinations and configurations, and further, other combinations and configurations including more, less, or only a single element thereof are also within the spirit and scope of the present disclosure.

According to the above-described first and second embodiments, the top view image and the remote parking image are displayed so as to be switched therebetween during remote parking. However, at least the remote parking image may be displayed. The top view image may not be displayed.

In addition, the see-through image described according to the first embodiment and the own-vehicle viewpoint image described according to the second embodiment can both be displayed as the remote parking image. The operator 110 may be capable of performing display switching by the image switching button 2c through the remote controller 2.

Furthermore, according to the first and second embodiments, the display timing of the remote parking image is when the image switching request is issued. That is, display of the remote parking image is performed when the operation to request image switching is performed in the remote controller 2 during remote parking, or when the automatic parking ECU 8 detects that the obstacle 120 is present in the position of a blind spot or is approaching the position of a blind spot. However, this is merely an example. The timing for switching to the remote parking image can be arbitrarily set.

For example, the remote parking image may be displayed at the start of remote parking and the top view image may be displayed after the start. In addition, the remote parking image and the top view image may be automatically switched at every fixed interval, that is, at every fixed time interval or fixed traveling distance interval. In these cases as well, when the automatic parking ECU 8 detects that an obstacle is present in the position of a blind spot or is approaching the position of a blind spot during remote parking, switching to remote parking image is preferably performed.

Furthermore, regarding remote parking, the driver becoming the operator 110 after disembarking from the own vehicle V and performing remote parking is assumed. Therefore, the startup switch is turned on only when the electronic key 1 is an authentic electronic key of the own vehicle V based on the key authentication. However, this is merely an example that is used. The startup switch may be automatically turned on when the operator 110 issues a request for the start instruction for remote parking through the remote controller 2, without the key authentication being performed. In addition, the operator 110 may disembark from the own vehicle V and perform remote parking in a state in which the startup switch remains turned on without being turned off.

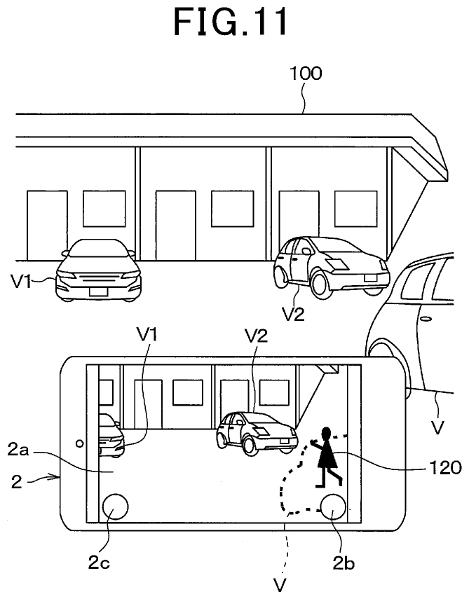

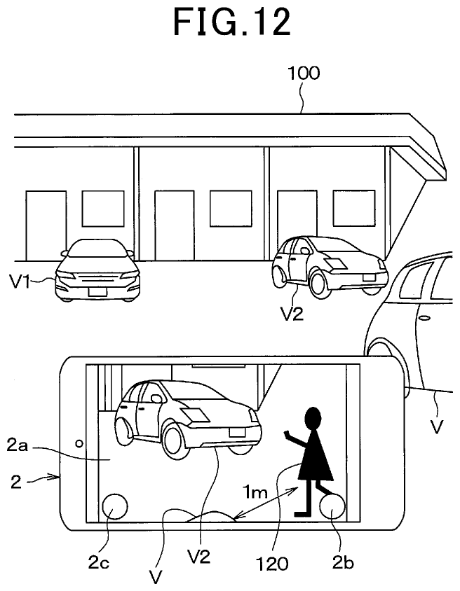

Furthermore, according to the above-described first embodiment, as the see-through image, an image in which the own vehicle V is removed is displayed on the display screen 2a. However, as shown in FIG. 11, an aspect is also possible in which the blind spot position is displayed while the outer shape of the own vehicle V is displayed by a broken line or the like. In addition, according to the above-described second embodiment, as the own-vehicle viewpoint image, the blind spot position is displayed from the blind-spot-position side of the own vehicle V. However, as shown in FIG. 12, a portion of the own vehicle V may be displayed in the own-vehicle viewpoint image as well. As a result, the distance between the own vehicle V and the obstacle 120 can be more easily imagined.

Moreover, in the see-through image and the own-vehicle viewpoint image, when the aspect is such that even a portion of the own vehicle V is displayed, a display in which a distance from a location of the own vehicle V that is at a shortest distance to the obstacle 120 to the obstacle 120 is directly known can be performed. As a result of distance display such as this being performed, the operator 110 can be caused to more easily recognize a specific distance between the own vehicle V and the obstacle 120. For example, a radiating distance display from the location of the own vehicle V that is at the shortest distance from the obstacle 120 towards the obstacle 120 can be considered. Alternatively, as shown in FIG. 12, a distance being added and displayed on a straight line that connects the location of the own vehicle V that is at the shortest distance from the obstacle 120 and the obstacle 120 can be considered.

In addition, a method by which the parking assistance control apparatus (such as the body ECU 5) acquires the position of the remote controller 2 is not limited to the aspect described above. The parking assistance control apparatus can acquire the position of the remote controller 2 relative to the vehicle by performing wireless communication with the remote controller 2. For example, the parking assistance control apparatus may estimate a relative position of the remote controller 2 based on a distance from each short-range communication apparatus that is mounted in a plurality of sections of the vehicle to the remote controller 2 that is prescribed by the short-range communication apparatus being caused to perform wireless communication with the remote controller 2.

As an estimation method for the distance from the short range communication apparatus to the remote controller 2, a Received Signal Strength (RSS) method using reception signal strength or a Time Of Flight (TOF) method using a round-trip time of a signal is applicable. Furthermore, in the position estimation of the remote controller 2, an Angle Of Arrival (AOA) method is applicable. More specifically, a method disclosed in Japanese Patent Publication No. 6520800 or the like can be widely applied. As a communication method between the parking assistance control apparatus and the remote controller 2, Bluetooth (registered trademark), Wi-Fi (registered trademark), Ultra Wide Band (UWB), or the like can be used.

Here, the control unit of the parking assistance control apparatus and the methods thereof described in the present disclosure may be implemented by a dedicated computer that is provided so as to be configured by a processor and a memory, the processor being programmed to provide one or a plurality of functions that are realized by a computer program. Alternatively, the control unit and the methods thereof described in the present disclosure may be implemented by a dedicated computer that is provided by a processor being configured by a single dedicated hardware logic circuit or more. As another alternative, the control unit and the methods thereof described in the present disclosure may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory computer-readable (tangible) storage medium that can be read by a computer as instructions to be performed by the computer.

What is claimed is:

1. A remote parking system that performs remote parking in which a vehicle is moved from a current position to a parking intended position and parked by remote parking, the remote parking system comprising:
a remote controller that is an apparatus that can be carried outside the vehicle, issues an instruction for remote parking by being operated by an operator, and includes a display screen that displays a state of remote parking;
an imaging apparatus that is provided in the vehicle and captures a peripheral image of the vehicle; and
a control unit that is provided in the vehicle, inputs imaging data of the peripheral image from the imaging apparatus, and includes an image generating unit that generates an image to be displayed on the display screen based on the imaging data, wherein
the image generating unit generates, as a remote parking image, an image in a direction along a line of sight in which a vehicle direction is viewed from the operator, the image including a blind spot position that is positioned on a side opposite the operator relative to the vehicle.

2. The remote parking system according to claim 1, wherein:
the image generating unit generates a see-through image that is an image in which the vehicle is transparent, and the blind spot position is included, as the remote parking image.

3. The remote parking system according to claim 1, wherein:
the image generating unit generates an own-vehicle viewpoint image that is an image in which the blind spot position is displayed from the blind-spot-position side of the vehicle, as the remote parking image.

4. The remote parking system according to claim 1, wherein:
the image generating unit generates a top view image that is an image in which the vehicle is viewed from directly above; and
the image generating unit generates the top view image and the remote parking image so as to switch therebetween.

5. The remote parking system according to claim 2, wherein:
the image generating unit generates a top view image that is an image in which the vehicle is viewed from directly above; and
the image generating unit generates the top view image and the remote parking image so as to switch therebetween.

6. The remote parking system according to claim 3, wherein:
the image generating unit generates a top view image that is an image in which the vehicle is viewed from directly above; and
the image generating unit generates the top view image and the remote parking image so as to switch therebetween.

7. The remote parking system according to claim 4, wherein:
the remote controller performs an operation for an image switching instruction that instructs which of the top view image and the remote parking image is to be displayed; and
the image generating unit performs image generation so as to switch between the top view image and the remote parking image based on the image switching instruction from the remote controller.

8. The remote parking system according to claim 4, wherein:
the control unit includes a space recognizing unit that recognizes an obstacle that is present in a vicinity of an own vehicle by recognizing a surrounding environment of the own vehicle; and
the image generating unit generates the remote parking image and displays the remote parking image on the display screen in response to the space recognizing unit recognizing the obstacle.

9. The remote parking system according to claim 8, wherein:
the control unit includes a space recognizing unit that recognizes an obstacle that is present in a vicinity of an own vehicle by recognizing a surrounding environment of the own vehicle; and
the image generating unit generates the remote parking image and displays the remote parking image on the display screen in response to the space recognizing unit recognizing the obstacle.

10. The remote parking system according to claim 4, wherein:
the image generating unit generates the remote parking image and displays the remote parking image on the display screen in response to the remote controller issuing a start instruction for remote parking and in response to remote parking being started, and generates the top view image and displays the top view image on the display screen after the start of remote parking.

11. The remote parking system according to claim 7, wherein:
the image generating unit generates the remote parking image and displays the remote parking image on the display screen in response to the remote controller issuing a start instruction for remote parking and in response to remote parking being started, and generates the top view image and displays the top view image on the display screen after the start of remote parking.

12. The remote parking system according to claim 8, wherein:
the image generating unit generates the remote parking image and displays the remote parking image on the display screen in response to the remote controller issuing a start instruction for remote parking and in response to remote parking being started, and generates the top view image and displays the top view image on the display screen after the start of remote parking.

13. The remote parking system according to claim 9, wherein:
the image generating unit generates the remote parking image and displays the remote parking image on the display screen in response to the remote controller issuing a start instruction for remote parking and in response to remote parking being started, and generates the top view image and displays the top view image on the display screen after the start of remote parking.

14. The remote parking system according to claim 1, wherein:
the control unit includes
a key authenticating unit that performs wireless communication with an electronic key that has authentication data, and performs key authentication to determine whether the electronic key is an authentic electronic key of an own vehicle, and
a power supply control unit that controls an on/off state of a startup switch of the own vehicle, and
in response to the remote controller issuing a start instruction for remote parking, the key authenticating unit performs the key authentication, and in response to the electronic key being determined to be an authentic electronic key of the own vehicle as a result of the key authentication, the power supply control unit turns on the startup switch and remote parking is performed.

15. The remote parking system according to claim 1, wherein:
the control unit acquires a position of the remote controller by performing wireless communication with the remote controller; and
the image generating unit identifies an orientation and a display area of the remote parking image based on an orientation of the vehicle from the position of the remote controller and a blind spot position that is hidden by the vehicle that are acquired from position information of the remote controller and position information of the vehicle.

16. A parking assistance control apparatus that performs remote parking in which a vehicle is moved from a current position to a parking intended position and parked based on an operation in a remote controller that can be carried outside the vehicle, the parking assistance control apparatus comprising:
a control unit that inputs imaging data of a peripheral image from an imaging apparatus that captures the peripheral image of the vehicle and includes an image generating unit that performs generation of an image to be displayed on a display screen based on the imaging data, wherein
the control unit
causes the image generating unit to generate, as a remote parking image, an image to be displayed on the display screen, the image being in a direction along a line of sight in which a vehicle direction is viewed from the operator and including a blind spot position that is positioned on a side opposite an operator of the remote controller relative to the vehicle, and
subsequently transmits the remote parking image to the remote controller and causes a display screen of the remote controller to display the remote parking image.
